(19) United States
(12) Patent Application Publication
(10) Pub. No.: US 2010/0256804 A1
(43) Pub. Date: Oct. 7, 2010

(54) System and method for separation of food particles

(76) Inventor: Rhonda Freeman, Chicago, IL (US)

Correspondence Address: Law Office of Martin Jerisat;Suite 3300, 10 S. Lasalle Street, Chicago, IL, 60603, US

(21) Appl. No.: 12/384,454

(22) Filed: Apr. 6, 2009

(51) Int. Cl. B07B 1/42; B07B 1/28; G06F 7/00

(52) U.S. Cl. 700/223; 209/235; 209/606

(57) ABSTRACT

A system and method for separating food particles is disclosed here. The system may include means for receiving food particles to be separated, means for screening the food particles into fine and coarse particles, means for controlling the amount of output fine particles, and means for delivering the output for further processing. The method may include receiving food particles to be separated, mechanically screening the food particles into fine and coarse particles, controlling the amount of the fine particles output, and delivering the fine output for further processing.

### BACKGROUND

1. Field

The invention is generally related to a system and method for separating food particles.

2. Background of the Invention

The invention relates to a system and method for particularly separating grain particles and preparing predetermined quantities of grain. This invention has particular applications in bakeries and food processes.

Current separating systems in bakeries use manual separation. Bakers have to manually shake the sifter to separate the fine from the coarse particles. Bakers do not control or predetermine the necessary amount of input flour needed to produce the required amount of fine flour output.

Accordingly, a system and method are needed to address this and other problems with the prior art systems.

### SUMMARY OF THE INVENTION

The objects mentioned above, as well as other objects, are solved by the present invention, which overcomes disadvantages, while providing new advantages not previously obtainable in the prior art.

In a preferred embodiment, a system for separating food particles is disclosed. The system may include means for receiving food particles to be separated, means for screening the food particles into fine and coarse particles, means for controlling the amount of output fine particles and means for delivering the output for further processing.

In an alternative embodiment, a system for separating food particles is disclosed. The system includes a receiver for receiving food particles to be separated, a screener for separating the food particles into fine and coarse particles, the screener is configured to produce predetermined amount of fine particles output, the screener is operatively associated with the receiver, and a conduit for delivering the fine output for further processing.

The separator may include shaking means for shaking the food particles to separate them according to their size or other criteria. The screener may also be associated with at least one sensor for sensing a property of the fine particles output, such as weight. The sensor may be configured to communicate or send signals to the separator to begin or terminate the screening process upon meeting certain predetermined criteria.

The shaking means may be operatively associated with means for measuring a property of the fine particles output, such as weight. The shaking means may be configured to be responsive to weights measurements of the fine particles output or other properties of the fine particles output.

In an alternative embodiment, a method for separating food particles is disclosed. The method may include the steps of receiving food particles to be separated, mechanically separating the food particles into fine and coarse particles, controlling the amount of the fine particles output, and delivering the fine output for further processing.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The novel features which are characteristic of the invention are set forth in the appended claims. The invention itself however, together with further objects and attendant advantages thereof, will be best understood by reference to the following description taken in connection with the accompanying drawings, in which:

FIG. 1 shows a perspective view of an embodiment in accord with the present invention;

FIG. 2 is a front view of another embodiment according to the present invention; and

FIG. 3 is a flowchart illustrating a method for separating food particles according to the present invention.

The components in the drawings are not necessarily to scale, emphasis instead being placed upon clearly illustrating the principles of the present invention. In the drawings, like reference numerals designate corresponding parts throughout several views.

### DETAILED DESCRIPTION

Set forth below is a description of what are believed to be the preferred embodiments and/or best examples of the invention claimed. Future and present alternatives and modifications to this preferred embodiment are contemplated. Any alternatives or modifications that make insubstantial changes in function, in purpose, in structure, or in results, are intended to be covered by the claims of this patent.

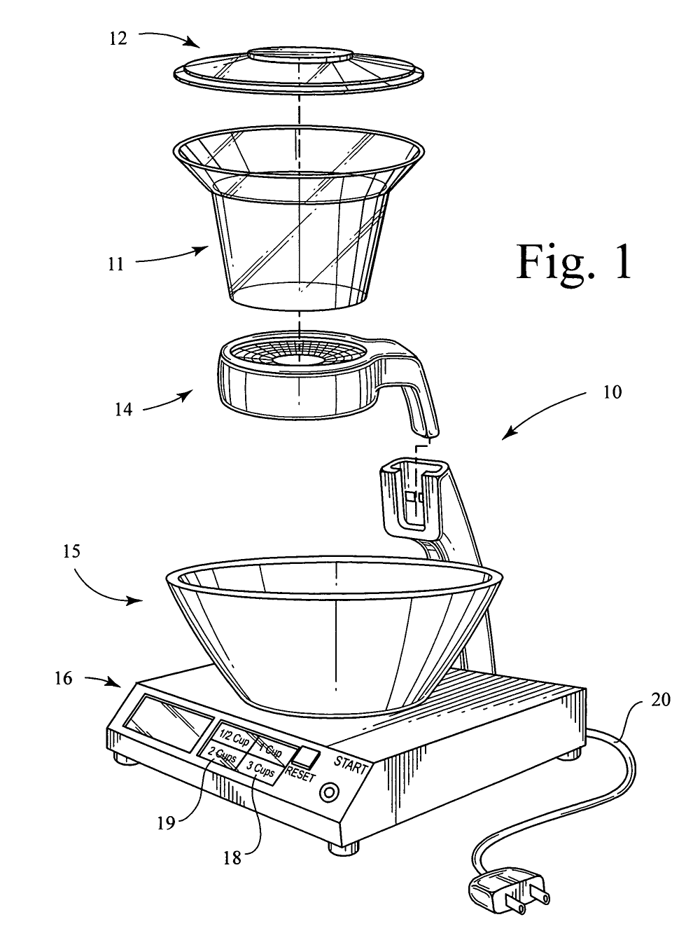

FIG. 1 shows a system 10 for separating food particles. System 10 may include a receiver 11 for receiving food particles to be separated. Receiver 11 may have a top cover part 12 and may be associated with a screener 14. Screener 14 may include a drive that induces vibration and a screen cloth that may cause particle separation, not shown. Separation may use vibration, g force, bed density, and material shape to facilitate the rate of separation. Vibration may be sinusoidal vibration that occurs at an angled plane relative to the horizontal. Vibration is in a wave pattern and may be determined by frequency and amplitude. Vibration may also be gyratory occurring at near level plane at low angles in a reciprocating side-to-side motion.

The screening cloth is a material that may be defined by mesh size, which can be made of any type of material such steel, stainless steel, rubber and so forth. The cloth may cause separation of fine particles from coarse particles of grain. Fine particles may flow through the cloth to a receptor or bowl 15 for further processing. Receptor 15 may be positioned on a scale 16 that may indicate the weight of fine particles that accumulate in receptor 15. The reading on scale 16 may be communicated to to system 10 to control the amount of fine particles produced.

A user controls system 10 through control panel 18 by choosing the required weight of fine particles of grain by pressing buttons 19. System 10 is configured to be responsive to control signals from control panel 18. A signal from control panel 18 controls the power and the voltage necessary for system 10 to produce the required weight of fine particles of grain. One aspect of novelty of system 10 is that it allows a user to control the output amount needed of fine grain particles. System 10 may be responsive to control signals from control panel 18 to produce determined amount of fine particles.

A user begins by depositing grain in receiver 11. A user then presses control panel buttons 19 to choose the required amount of fine particles desired. Control panel LED lights 19 may show the chosen amount. A user then may press control panel buttons 19 to start the screening process.

As the fine particles fall into receptor 15, the value indicating the weight of the fine particles changes accordingly as shown by LED lights 19. The value may begin to decrease until the required amount is reached. LED lights 19 may show zero reading to indicate that the amount chosen has be obtained.

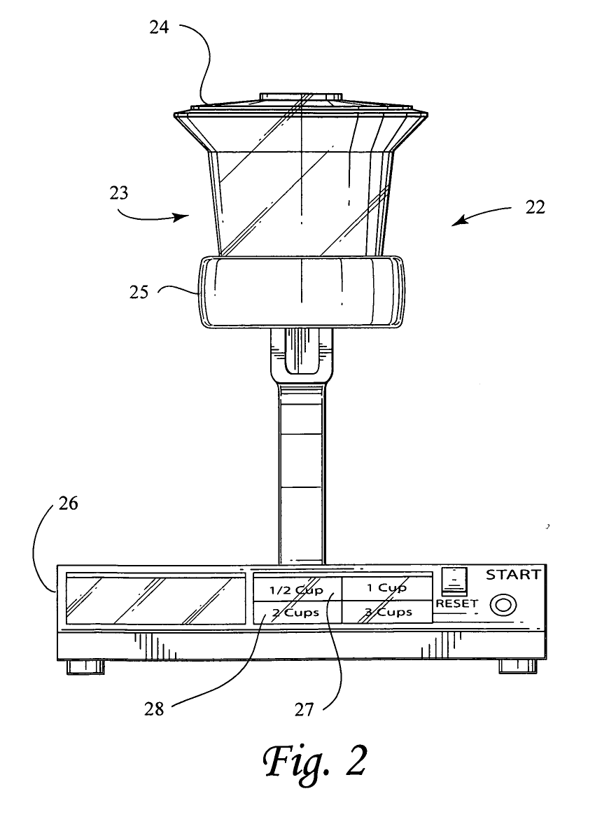

FIG. 2 shows another embodiment according to the present invention. System 22 may include a receiver 23 that may have a top cover 24. Receiver 23 may be operatively associated with a screener 25. Screener 25 may be a mechanical shaker that may be operatively associated with a membrane, not shown, to separate fine from coarse particles of grain or flour. Screener 25 may be operatively associated with a control panel 26 having control buttons 27 and LED lights 28. Control buttons 27 enable a user to control system 22 to produce predetermined amount or weight of fine particles. A user may press control buttons 27 to start the process of screening and separating fine form coarse particles. System 22 may include sensors to sense the amount of fine or coarse particles of grain produced in screener 25 and loop back the information to system 22 to adapt accordingly to continue or stop the screening process.

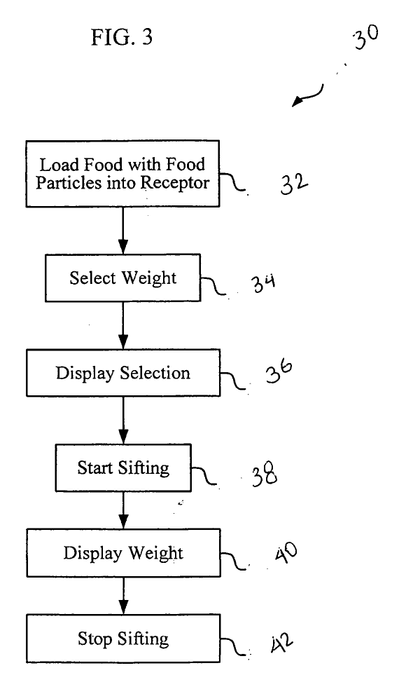

FIG. 3 is a flow chart of an exemplary method 30 of separating food particles. that may be employed using a system, such as, but not limited to, system 10 and/or system 22. Method 30 may be performed by any combination of hardware, software, and/or firmware. Method 400 may start with block 32, which includes loading a receiver, such as receiver 11, with food that includes food particles. In block 34, a selection for the weight of food particles desired may be selected or input. For example, block 34 may include selecting or inputting a desired weight of food particles using the one or more buttons 19.

In block 36, the system, for example system 10, may display the selected weight. For example, the selected weight may be displayed using the one or more LED lights 28. In block 38, the system, for example system 10, may start sifting the food particles from the food. In block 40, the system, for example system 10, may display the weight of the food particles accumulating in a receptor, for example receptor 15. In block 42, the system, for example system 10, may stop sifting when the weight of food particles in the receptor, for example receptor 15, reaches the selected weight.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein, for example those blocks shown in FIG. 3, may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

As mentioned above, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The above description of the disclosed embodiments is provided to enable any person skilled in the art to make or use that which is defined by the appended claims. The following claims are not intended to be limited to the disclosed embodiments. Other embodiments and modifications will readily occur to those of ordinary skill in the art in view of these teachings. Therefore, the following claims are intended to cover all such embodiments and modifications when viewed in conjunction with the above specification and accompanying drawings.

I claim:

1. A system for separating food particles, the system comprising:
(a) means for receiving food particles to be separated;
(b) means for screening the food particles into fine and coarse particles;
(c) means for controlling the amount of output fine particles; and
(d) means for delivering the output for further processing.

2. A system for separating food particles, the system comprising:
(a) a receiver for receiving food particles to be separated;
(b) a screener for separating the food particles into fine and coarse particles, the screener is configured to produce predetermined amount of fine particles output, the screener is operatively associated with the receiver; and
(c) a conduit for delivering the fine output for further processing.

3. The system of claim 2 wherein the screener comprises shaking means for shaking the food particles to separate them according to their size.

4. The system of claim 3 wherein the screener is associated with at least one sensor for sensing the amount of fine particles output, wherein the sensor is configured to communicate with the screener to begin or terminate the screening process upon meeting certain predetermined criteria.

5. The system of claim 3 wherein the shaking means is operatively associated with means for measuring the weights of the fine particles output.

6. The system of claim 5 wherein the shaking means is configured to be responsive to weights measurements of the fine particles output.

7. A method for separating food particles, the method comprising the steps of:
(a) receiving food particles to be separated;
(b) mechanically separating the food particles into fine and coarse particles;
(c) controlling the amount of the fine particles output; and
(d) delivering the fine output for further processing.
